(19) United States
(12) Patent Application Publication
(10) Pub. No.: US 2025/0303591 A1
(43) Pub. Date: Oct. 2, 2025

(54) Seal for a Radial Gap Between Two Links of a Robot Arm

(71) Applicant: KUKA Deutschland GmbH, Augsburg (DE)

(72) Inventors: Andre Reekers, Augsburg (DE); Jorge Torres, Neusaess (DE); Melina Nasradini, Augsburg (DE); Benjamin Kuhl, Augsburg (DE); Johannes Schwenk, Zusamzell (DE); Dieter Schaab, Augsburg (DE); Markus Berggold, Augsburg (DE)

(73) Assignee: KUKA Deutschland GmbH, Augsburg (DE)

(21) Appl. No.: 18/864,612

(22) PCT Filed: Apr. 27, 2023
(86) PCT No.: PCT/EP2023/061062

§ 371 Date: Nov. 11, 2024

(30) Foreign Application Priority Data
May 20, 2022 (DE) 10 2022 205 077.0

(51) Int. Cl. B25J 19/00

(52) U.S. Cl. CPC B25J 19/0075

(57) ABSTRACT

A robot arm having at least two links, which are connected to one another in a joint so as to be rotatable relative to each other about a rotational axis, and a sealing arrangement having a seal support attached to one of the two links, and an elastic seal, which, in order to seal a radial gap between this link and the other of the two links, is supported on the seal support and on the other link.

### CROSS-REFERENCE TO RELATED APPLICATIONS

This application is a national phase application under 35 U.S.C. § 371 of International Patent Application No. PCT/EP2023/061062, filed Apr. 27, 2023 (pending), which claims the benefit of priority to German Patent Application No. DE 10 2022 205 077.0, filed May 20, 2022, the disclosures of which are incorporated by reference herein in their entirety.

### TECHNICAL FIELD

The present invention relates to the sealing of a radial gap between two links of a robot arm.

### BACKGROUND

Robot arms often have a plurality of joints in which in each case two links of the robot arm are connected to one another in such a way that they can be rotated relative to each other about a rotational axis of the respective joint.

Radial shaft seals according to DIN 3760 are commonly used to seal radial gaps between components that can rotate relative to one another. However, these have fixed outer and inner diameters and widths, so that the components to be sealed must be adapted accordingly depending on the dimensions of the preselected radial shaft seal. In particular, this can lead to casing components and/or the shaft having to be made unnecessarily large and/or heavy in order to be able to install the corresponding radial shaft seal.

### SUMMARY

The object of the present invention is to improve the sealing of a radial gap between two links of a robot arm, preferably to reduce the aforementioned disadvantages, in particular to avoid them.

This object is achieved by a robot arm, a corresponding sealing arrangement and its use, and a method for sealing at least one radial gap of a robot arm as described herein.

According to one embodiment of the present disclosure, a robot arm comprises one or more pairs of links, each having two links, which are each connected to one another in a joint (of the respective pair of links) in such a way that they can be rotated relative to one another about a rotational axis (of the respective pair of links or joint), it being possible in one embodiment for the two links of the pair of links or one or more of the pairs of links to (each) be rotatable about the respective rotational axis by a drive, preferably an electric motor. In this case, a link of one pair of links can at the same time be a link of another pair of links of the robot arm. In one embodiment, the robot arm has at least three, in particular exactly or at least six, in one embodiment exactly or at least seven, joints.

According to one embodiment of the present disclosure, in order to seal a radial gap between one link of the pair of links or one or more of the pairs of links, which in the present case is also referred to, without restriction of generality, (in each case) as the first link (of the (respective) pair of links) and the other link of this (respective) pair of links, which in the present case is referred to, without restriction of generality, (in each case) as the second link (of this (respective) pair of links) a sealing arrangement is provided or used (in each case), which (in each case) has a seal support which is attached to the (respective) one or first of the two links, and an elastic seal which, in order to seal the (respective) radial gap between the (respective) one or first and the (respective) other or second of the (respective) two links, is supported on the one hand on this seal support and on the other hand on the (respective) other or second link, preferably (at least) in the radial direction, in particular is tensioned or compressed between them (at least in the radial direction).

Because in one embodiment a separate seal support is used (in each case), the two links in one embodiment can advantageously be dimensioned (more) freely. Additionally or alternatively, in one embodiment, material and thus weight can be reduced thereby, in particular with regard to the (respective) one or first link. Additionally or alternatively, in one embodiment, the seal support and/or the seal can thereby be adapted (more) easily without having to modify the one or first and/or the other or second link. Additionally or alternatively, in one embodiment this allows the seal support and/or the seal to be assembled, disassembled, maintained and/or inspected more easily.

The one or first link of the pair of links or one or more of the pairs of links can in particular be (in each case) a more proximal or (more) base-side link of the robot arm; the other or second link of this or these pair(s) of links can accordingly be a more distal or (more) end-effector-side link of the robot arm. This can be particularly advantageous because it eliminates the need for more distal links to bear the weight of the sealing arrangement described below. Likewise, the one or first link of the pair of links or one or more of the pairs of links can be (in each case) a more distal or (more) end-effector-side link of the robot arm; the other or second link of this or these pair(s) of links can accordingly be a more proximal or (more) base-side link of the robot arm. The present invention can also be particularly advantageous in this case, in particular since, as explained below, the weight of the first link can be reduced.

In one embodiment, the seal support and/or the elastic seal is ring-like.

In one embodiment, this can improve the sealing effect and/or the installation.

In one embodiment, the seal support and/or the elastic seal is (in each case) formed in a single part.

As a result, in one embodiment the weight can be (further) reduced.

In one embodiment, the seal support and/or the elastic seal is (in each case) formed in multiple parts.

In one embodiment, this can (further) improve the assembly and/or function.

In particular, in this case, the seal support can also be formed in a single part and the elastic seal in multiple parts or, conversely, the seal support can be formed in multiple parts and the elastic seal in a single part.

In one embodiment, the seal support or one or more of the seal supports are frictionally attached (in each case) to the (respective) one or first link, in one embodiment in such a way or by virtue of the fact that there is an interference fit between the seal support and the one or first link, and/or by pressing in or on, preferably in the axial direction, and/or shrinking. In the present embodiment, “axial” refers to the (respective) rotational axis, “radial” accordingly refers to a direction perpendicular to the (respective) rotational axis and the rotational or circumferential direction around it, preferably away from the (respective) rotational axis toward the outside.

In this way, in one embodiment an advantageous, preferably low-vibration attachment can be realized.

Additionally or alternatively, this seal support or one or more of these seal supports and/or one or more further seal supports is positively attached (in each case) to the (respective) one or first link, in one embodiment secured, preferably fixed or fastened, in the axial, radial and/or circumferential direction.

In this way, in one embodiment an advantageous, preferably (more) robust, attachment can be realized.

Additionally or alternatively to positive and/or frictional attachment, one or more of the seal supports are attached (in each case) in an integrally locking manner to the (respective) one or first link, in one embodiment by gluing and/or welding.

In this way, in one embodiment an advantageous, preferably (more) reliable attachment can be realized.

Particularly preferred is the combination of gluing with pressing and/or shrinking, whereby, as mentioned above, a particularly reliable and at the same time low-vibration attachment can be achieved.

In one embodiment, the seal support or one or more of the seal supports are attached (in each case) in a radial, preferably front-side, recess of a wall of the (respective) one or first link, preferably with thin walls in this region, preferably in a recess that is open toward a front side of this wall and/or is ring-like.

In one embodiment this allows the seal support to be positioned (more) reliably, (more) compactly, (more) simply and/or so as to be (more) protected.

In one embodiment, the seal support or one or more of the seal supports are arranged (in each case) on an inner side of the (respective) one or first link.

This allows the seal support to be positioned (more) reliably, (more) compactly and/or so as to be (more) protected in one embodiment.

In one embodiment, the seal support or one or more of the seal supports are arranged (in each case) on an outer side of the (respective) one or first link.

This allows the seal support to be positioned (more) easily and/or the link to be dimensioned advantageously in one embodiment.

In one embodiment, the elastic seal or one or more of the elastic seals are arranged (in each case) on an inner side of the (respective) other or second link.

In one embodiment, this allows the seal to be positioned (more) reliably, (more) compactly and/or so as to be (more) protected.

In one embodiment, the elastic seal or one or more of the elastic seals are arranged (in each case) on an outer side of the (respective) other or second link.

In one embodiment, this makes it easy (easier) to position and/or maintain the seal.

In one embodiment, the elastic seal or one or more of the elastic seals are (in each case) supported in a radial, preferably front-side, recess of a wall of the (respective) other or second link, which wall is preferably thin-walled in this region, preferably in a recess that is open toward a front side of this wall and/or is ring-like.

In one embodiment, this makes it easy (easier) to mount and/or maintain the seal.

In one embodiment, the seal support or one or more of the seal supports (each) have a radial recess, in a development a radial groove, in which the (respective) seal is supported, in one embodiment is axially secured on one or both sides.

In one embodiment, this allows the seal to be positioned (more) reliably and/or (more) compactly and/or so as to be (more) protected.

In one embodiment, the first link or one or more of the one or first links is (in each case) a single- or multi-part metal and/or cast component.

This is particularly advantageous for robot arm links, due to their shape and stability requirements. The invention can be used with particular advantage especially for (metal) cast parts, since the seal support(s) make it possible for significant amounts of material and thus weight to be saved, or allow (more) advantageous dimensions to be realized for the casting.

Additionally or alternatively, in one embodiment the seal support or one or more of the seal supports are (in each case) a single- or multi-part metal component. This allows the associated seal to be supported (more) reliably in one embodiment.

Additionally or alternatively, in one embodiment the first link or one or more of the one or first links and the (respective) seal support attached thereto are (each) made from different materials. In one embodiment, the first link or one or more of the one or first links and the (respective) seal support attached thereto are (each) made of the same material.

In one embodiment, using links and seal supports made of different materials makes it possible for the weight to be (further) reduced, and in one embodiment using links and seal supports made of the same material makes it possible for their connection to be improved.

Additionally or alternatively, in one embodiment the seal support or one or more of the seal supports and the (respective) seal supported thereon are (each) made of different materials and/or the seal or one or more of the seals are (each) a single- or multi-part plastics component.

As a result, in one embodiment the sealing effect can be improved.

In one embodiment, the first link or one or more of the one or first links and/or the seal support or one or more of the seal supports comprises aluminum, in particular at least one aluminum alloy.

As a result, in one embodiment the weight can be (further) reduced.

In one embodiment, the sealing arrangement or one or more of the sealing arrangements are (each) designed such that sealing between the two links by the (respective) seal meets at least protection class IP5 and/or IP54, in particular according to ISO 20653 and/or DIN EN 60529.

In this way, in one embodiment the robot arm can be designed or used in a particularly advantageous manner.

As mentioned above, the present disclosure also relates to the use of one or more sealing arrangements as described here for sealing radial gaps between two links of a robot arm which are connected to one another in a joint so as to be rotatable relative to one another about a rotational axis, to a sealing arrangement having a seal support and an elastic seal for sealing the radial gap between two links of a robot arm which are connected to one another in a joint so as to be rotatable relative to one another about a rotational axis as described here, and to a method for sealing a radial gap between the one or first and the other or second of (respectively) two links of one or more pairs of links of a robot arm as described here. In this case, the advantages mentioned here apply equally to the use, sealing arrangement and method.

In one embodiment, the seal support or one or more of the seal supports are (in each case) attached to the (respective) one or first link, and in the process or during, preferably by, this attachment, the (respective) elastic seal for sealing the radial gap between the seal support and the other or second link is tensioned, preferably tensioned or compressed (at least) in the radial direction. In one embodiment, this can improve the mounting of the seal.

In one embodiment, the seal support or one or more of the seal supports are (in each case) attached to the (respective) one or first link, and then or when the seal support is already attached, the (respective) elastic seal for sealing the radial gap between the seal support and the other or second link is preferably tensioned (at least) in the radial direction, in particular compressed, in one embodiment by mounting the (respective) other or second link on the one or first link. As a result, in one embodiment the links can be simplified.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a robot arm according to one embodiment of the present disclosure; and

FIG. 2 schematically depicts a detail of a joint of the robot arm in an axial section.

### DETAILED DESCRIPTION

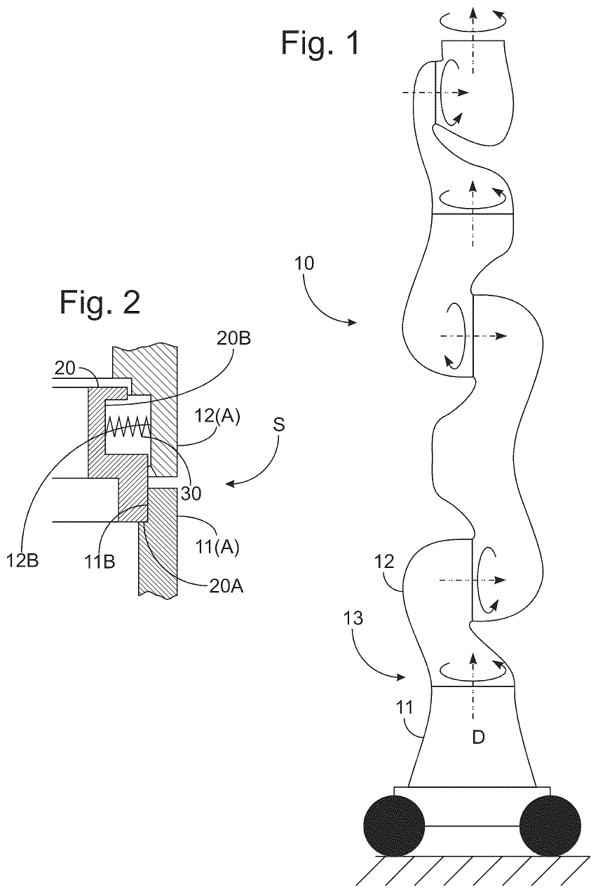

FIG. 1 shows, by way of example, a six-axis robot arm, which is preferably intended or configured or used for collaboration with humans and/or is arranged on a mobile platform in one embodiment. A seal in accordance with the present disclosure is particularly suitable for this because of the respectively typical boundary conditions in this case, but without being limited thereto.

In FIG. 2, a detail of the base frame 11 and the carousel 12, which are connected to one another in a proximal rotary joint 13 so as to be rotatable about a vertical rotational axis D, is shown in an enlarged section. The present invention is explained below by way of example on the basis of this example, since this joint represents a particularly preferred application. Additionally or alternatively, a seal according to the present disclosure can also be advantageously used in other joints, for example the subsequent joint with a horizontal rotational axis. As explained above, the designation of one link (in the example the base frame 11) as “first link” and the other link (in the example the carousel 12) as “second link” is used without restriction of generality, although it may be particularly advantageous if the more proximal link in each case is the one or first link.

FIG. 2 shows (a part of) a ring-like seal support 20, which has an axial flange 20A, which is pressed into a front-side radial recess 11B in a wall 11A of the base frame 11 and additionally glued therein and is thereby arranged on an inner side of the base frame 11.

A ring-like elastic seal 30 is supported radially on the one hand in a radial annular groove 20B of the seal support 20 and on the other hand in a front-side radial recess 12B in a wall 12A of the carousel 12 and is compressed between them in the radial direction. Due to the support in the annular groove 20B, it is secured axially on both sides (upward and downward in FIG. 2).

This advantageously seals a radial gap S between the base frame 11 and the carousel 12.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 robot arm
11 base frame
11A wall
11B radial recess
12 carousel
12A wall
12B radial recess
13 joint
20 seal support
20A flange
20B radial groove
30 elastic seal
D rotational axis
S radial gap

What is claimed is:

1. Robot arm having at least two links (11, 12), which are connected to one another in a joint (13) so as to be rotatable relative to each other about a rotational axis (D), and a sealing arrangement having a seal support (20), which is attached to one of the two links, and an elastic seal (30), which, in order to seal a radial gap (S) between this link and the other of the two links, is supported on the one hand on the seal support and on the other hand on the other link.

2-16. (canceled)

17. Robot arm according to claim 1, characterized in that the seal support is attached to the one link in a frictionally, positively and/or integrally locking manner.

18. Robot arm according to claim 1, characterized in that the seal support is attached in a radial recess (11B) of a wall (11A) of the one link and/or there is an interference fit between the seal support and the one link.

19. Robot arm according to claim 1, characterized in that the seal support is arranged on an inner side of the one link.

20. Robot arm according to claim 1, characterized in that the seal support is arranged on an outer side of the one link.

21. Robot arm according to claim 1, characterized in that the seal is arranged on an inner side of the other link.

22. Robot arm according to claim 1, characterized in that the seal is arranged on an outer side of the other link.

23. Robot arm according to claim 1, characterized in that the seal is supported in a radial recess (12B) of a wall (12A) of the other link.

24. Robot arm according to claim 1, characterized in that the seal support comprises a radial recess, in particular groove (20B), in which the seal is supported, in particular axially secured.

25. Robot arm according to claim 1, characterized in that the one link is a single- or multi-part metal and/or cast component, and/or the seal support is a single- or multi-part metal component, and/or the seal is a single- or multi-part plastics component, and/or the seal support and the seal are made of different materials.

26. Robot arm according to claim 1, characterized in that the seal support and the one link are made of different materials.

27. Robot arm according to claim 1, characterized in that the seal support and the one link are made of the same material.

28. Robot arm according to claim 1, characterized in that the sealing between the two links by the seal meets at least protection class IP5 and/or IP54.

29. Use of a sealing arrangement having a seal support (20) and an elastic seal (30) for sealing the radial gap (S) between the two links (11, 12) of a robot arm (10) according to claim 1, which are connected to one another in the joint (13) so as to be rotatable relative to one another about the rotational axis (D).

30. Sealing arrangement having a seal support (20) and an elastic seal (30) for sealing the radial gap (S) between the two links (11, 12) of a robot arm (10) according to claim 1, which are connected to one another in a joint (13) so as to be rotatable relative to one another about the rotational axis (D).

31. Method for sealing a radial gap (S) between one link and the other of two links (11, 12) of at least one pair of links of a robot arm (10), in particular according to claim 1, which are connected to one another in a joint (13) so as to be rotatable relative to one another about a rotational axis (D), wherein a seal support (20), in particular of a sealing arrangement according to claim 15, is attached to the one link, and during or after this an elastic seal (30), in particular the seal of the sealing arrangement according to claim 15, is tensioned between the seal support and the other link in order to seal the radial gap.
